(19) United States
(12) Patent Application Publication
(10) Pub. No.: US 2008/0029208 A1
(43) Pub. Date: Feb. 7, 2008

(54) Bead locator and a method of producing decorative sequences of beads for garments with the locator

(76) Inventor: Man Suk Paek, Los Angeles, CA (US)

Correspondence Address: Eugene Oak, Ph.D., J.D., M. Div., 610 S. Van Ness Ave., Los Angeles, CA, 90005, US

(21) Appl. No.: 11/497,442

(22) Filed: Aug. 2, 2006

(51) Int. Cl. B32B 37/00

(52) U.S. Cl. 156/249; 156/459; 156/543

(57) ABSTRACT

A locator for placing a bead of predetermined size into a circular groove developed on a rubber plate and a method of producing decorative sequences of beads for garments with the locator are provided. The locator is a box type means whose upper side and bottom side are open. Pluralities of blades are vertically located at the bottom side. Lower end of the blades are covered with a layer of rubbery foam material inside and a cotton texture out side. The circular grooves on the rubber plate have various diameters and form an ornament drawing. The rubber plate is adhered onto a conveyer belt. Beads of different diameter are placed into circular grooves that match the diameter. Bottom surface of the beads are flat and are coated with high temperature melting adhesive. After all the beads are placed into the grooves of decorative sequences, a transparent plastic film, paved with a sticky resin layer (low temperature melting adhesive), is pressed on the rubbery plate by passing through a pair of first feeding rollers. Beads come out of the circular grooves and adhered to the transparent plastic film. The plastic film is covered with peel off. The peel off covered plastic film is cut into desired size. Customer removes the peel off and places the plastic film on a garment and press the film on the garment with a heat press.

### FIELD OF THE INVENTION

Current invention is related with a bead locator, especially a bead locator that locates a bead of predetermined diameter to a circular groove of same diameter, and a method of producing decorative sequences of beads for garments with the locator.

### BACKGROUND OF THE INVENTION

Decorating a garment with sparkling beads is well known since 1960's. Since then many kind of beads of different material and design are known to market. However, beads of various sizes and different material are needed to make an ornament design. Therefore, placing the decorative beads is done by manual methods. So it takes long time and manufacturing cost is very high. Though some garment manufacturer used some automated machine combined with computer, that method is locating beads directly on a garment. Then, some kind of robot arms combined with computer is needed. But, such machinery operation on a garment may destroy the garment itself. It is the purpose of the current invention to provide a simple, safe and cheap method to produce ornamentally designed sequences decorating beads for garment and tools to realize that procedure. By producing pre-made sequences of decorating beads and apply them directly to a garment by heat pressing, the cost of placing the beads on a garment lowered drastically. And the chance of destroying garment decreased too.

### DESCRIPTION OF THE PRIOR ARTS

U.S. Pat. No. 6,982,115 to Poulos, et al. illustrates an interactive-design garment which has heat-affixed thereto a flexible substrate formed of a laminate including a layer of plastisol ink which includes a primary graphic image therein of a particular theme and a plurality of flexible PVC sheet appliques which have secondary graphic images thereon and are positionable onto the substrate by a user to cooperate artistically with the graphic theme of said substrate on the garment. U.S. Pat. No. 6,165,589 to Calvanella illustrates a grid tool to arrange glass elements, particularly small cylinders of Venetian-type glass, on a basic sheet or flat surface and possibly a masking implement or a plurality of masking implements, to selectively mask part of the holes in the grid. The sheet of glass with small cylinders resting on it is then subjected to heating, at temperatures between 400 and 1100 .degree. C. U.S. Pat. No. 4,944,969 to Usui illustrates a multipurpose board that has a frame circumferentially supporting at least three transparent plates with segregating clearances between the transparent plates. Particles partially fill each segregating clearance, the particles in the respective segregating clearances having different physical properties. When the board is moved, particle flow in each segregating clearance permitted by the only partial filling thereof forms varieties of wave-like combinations when movement is stopped, which are visible three dimensionally through the transparent plates. U.S. Pat. No. 3,977,581 to Franzson illustrates a kit for applying a decorative pattern to a garment utilizing a number of pronged studs. The kit includes a pattern formed by a plurality of dots on a surface material and a tool having a concave recess capable of fitting over the prongs of the studs and bending them inwardly upon application of a force. A base member is included having a flat support surface and capable of being easily penetrated by the prongs. The kit is utilized to apply the decoration with the head of the studs used as the ornamental part of the decoration, or ornamental stones can be placed within the prongs of the studs and held by the prongs so that the ornamental stones form the decorative pattern. U.S. Pat. No. 3,708,804 to Santos illustrates a decorative garment accessory which may take any number of different forms such as a belt, an accessory attachment for a belt, a shirt or blouse dickey, a sleeve, hem or other border finishing accessory or the like comprising an elongated, relatively narrow mounting strip having a plurality of spaced apart, generally parallel slots oriented generally transverse to the longitudinal axis of the strip, and decorative elements detachably attached to the strip by means of a staple formed on the back of each decorative element projecting through the slots in the mounting strip and an elongated retainer passing through the staples on the side of the strip opposite the decorative elements. U.S. Pat. No. 3,484,319 to Hirofumi illustrates a method of manufacturing a cloth having beads attached thereto, in which a predetermined pattern of beads is first laid out within a holding member, the pattern is transferred to the cloth, an adhesive is then applied to one or both sides of cloth in the pattern of the beads, and then the beads are attached by applying the cloth, which has the adhesive prepared thereto, over the patterned beads so that the patterned adhesive coincides with the patterned beads. U.S. Pat. No. 1,326,311 to Rudolph, et al. illustrates a method of manufacturing of an ornamental beaded fabric using sewing machine. U.S. Pat. No. 1,943,658 to Bertha illustrates a manufacturing method of a beaded fabric by applying glue directly to a fabric.

### SUMMARY OF THE INVENTION

A locator for placing a bead of predetermined size into a circular groove developed on a rubber plate and a method of producing decorative sequences for garments with the locator are provided. Diameter of the bead and that of the groove into which the bead is placed are the same. The locator is a box type means whose upper side and bottom side are open. Pluralities of blades are vertically located at the bottom side. Lower end of the blades are covered with a layer of rubbery foam material inside and a texture out side. The circular grooves on the rubber plate have various diameters and form an ornament drawing. The rubber plate is adhered onto a conveyer belt. Beads of different diameter are placed into circular grooves that match the diameter. Largest beads from first locator are placed into largest circular grooves first. Then second largest beads from second locator are placed into second largest circular grooves. After all the beads are placed into the grooves of decorative sequences, a transparent plastic film with a low temperature melting adhesive layer is pressed on the rubbery plate by passing through a set of first rollers. After the first rollers, the beads come out of the circular grooves and adhered to the transparent plastic film maintaining the ornament decorative sequences. Then the plastic film is covered with other plastic film, such as peel off. Meanwhile, the rubber plate returns to the first locator position. The peel off covered plastic film, which has beads adhered thereon, is wound as a roller or cut into desired size. Customer takes out the peel off and place the plastic film on a garment let the beads facing the garment. Press the film on the garment with a heat press. Then the ornament design of the beads is transferred to the garment.

### BRIEF DESCRIPTION OF DRAWINGS

FIG. 1 is a perspective drawing of a rubber plate according to current invention pluralities of circular grooves to receive decorative beads are developed thereon.

FIG. 2 is a cross sectional view of the rubber plate along the line A-A′ in FIG. 1.

FIG. 3 is a perspective view of a bead locator according to current invention.

FIG. 4 is an over view of a bead locator according to current invention.

FIG. 5 is a schematic drawing of the process of producing ornamentally designed sequence of beads containing tape.

FIG. 6 is a schematic cross sectional view showing how the locator place beads in circular grooves developed on a rubber plate.

FIG. 7 is a schematic cross sectional view showing how a low temperature melting adhesive paved plastic film picks up the beads.

FIG. 8 is a schematic cross sectional view showing coarse surfaced peel off is detachably adhered to the beads containing adhesive paved plastic film.

FIG. 9 is a schematic drawing how to transfer the ornamentally designed sequence of beads to a garment.

FIG. 10 is a schematic cross sectional view showing how the ornamentally designed sequence of beads is transferred to a garment.

### DETAILED DESCRIPTION OF THE PREFERRED EMBODIMENT

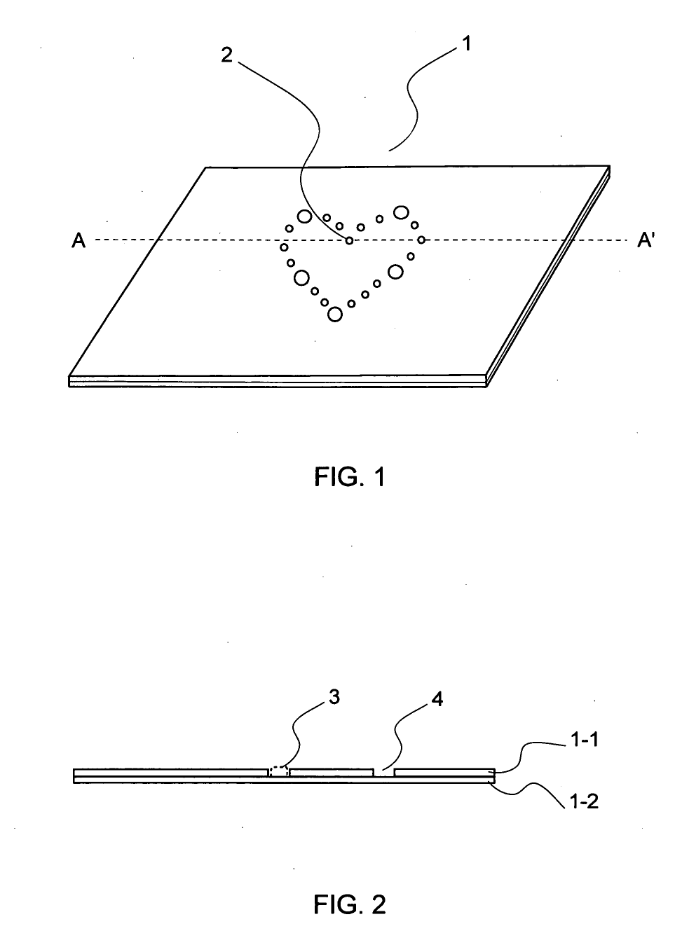

FIG. 1 is a perspective drawing of a rubber plate (1) according to current invention, pluralities of circular grooves (2) to receive decorative beads (3) are developed thereon. And FIG. 2 is a cross sectional view of the rubber plate (1) along the line A-A′ in FIG. 1. The rubber plate (1) is comprised of two plates (1-1) and (1-2). One rubber plate constitutes an upper rubber plate (1-1), which has pluralities of holes (4). And the other constitutes a lower rubber plate (1-2). When these two plates (1-1) and (1-2) are combindly adhered together, the holes (4) on the upper rubber plate (1-1) becomes the circular grooves (2) of the rubber plate (1).

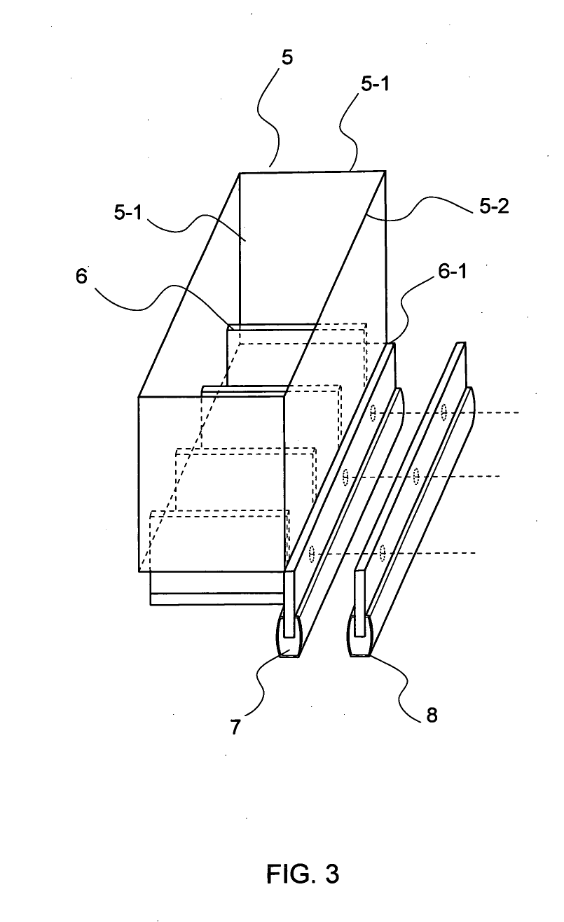

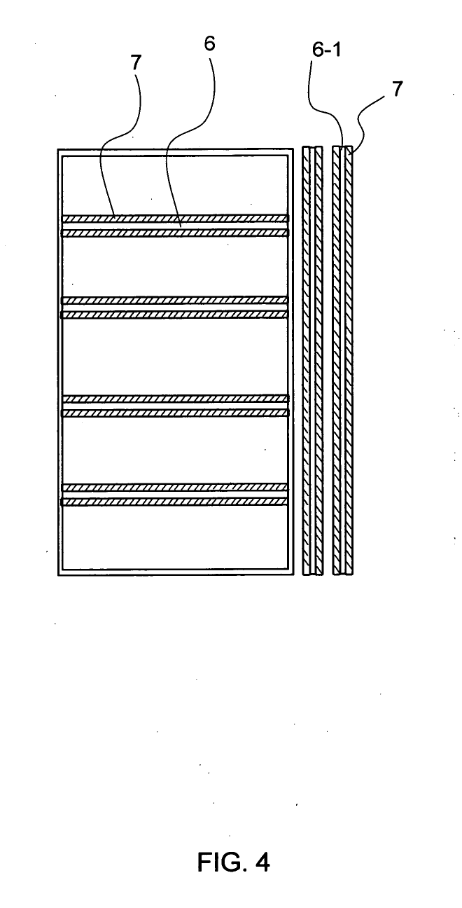

FIG. 3 is a perspective view of a bead locator (5) according to the current invention. And FIG. 4 is an over view of a bead locator (5) according to current invention. The locator (5) is a square box type means whose upper side and bottom side are open. Pluralities of blades (6) are located at the bottom side across short side of the locator (5) and vertical to ground surface. Additional blades (6-1) are located at the bottom of out side of the locator (5) along long side. Lower end of the blades (6), (6-1) are covered with a layer of rubbery foam (7) material inside and a texture (8) out side. The first step is to fill up the locator (5) with beads (3) of predetermined size.

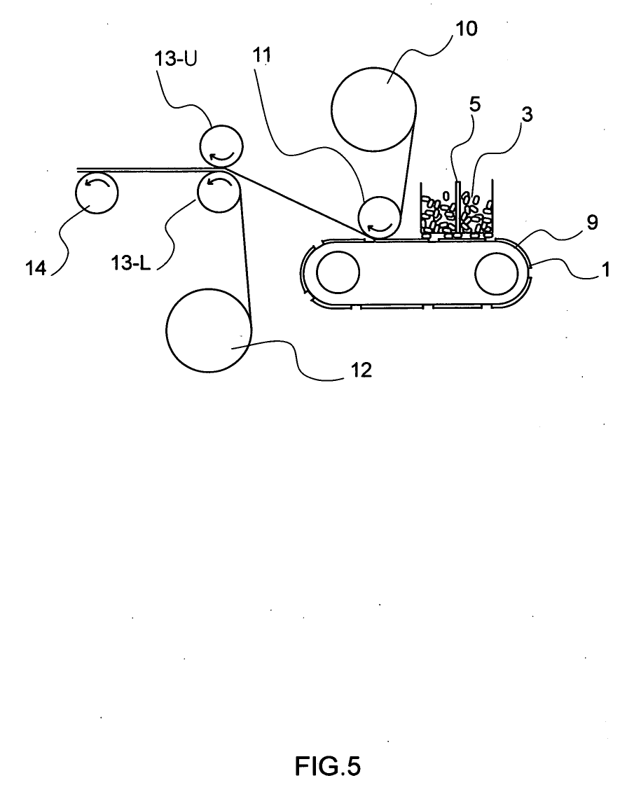

FIG. 5 is a schematic drawing of the process of producing ornamentally designed sequence of beads containing tape. The process is comprised of a conveyer belt (9), bead locators (5), and rubber piate (1), roll of low temperature melting adhesive paved plastic film (10), first feeding roller (11), roll of coarse surfaced peel off (12), a pair of second feeding rollers (13-U), (13-L), and a winding roller (14).

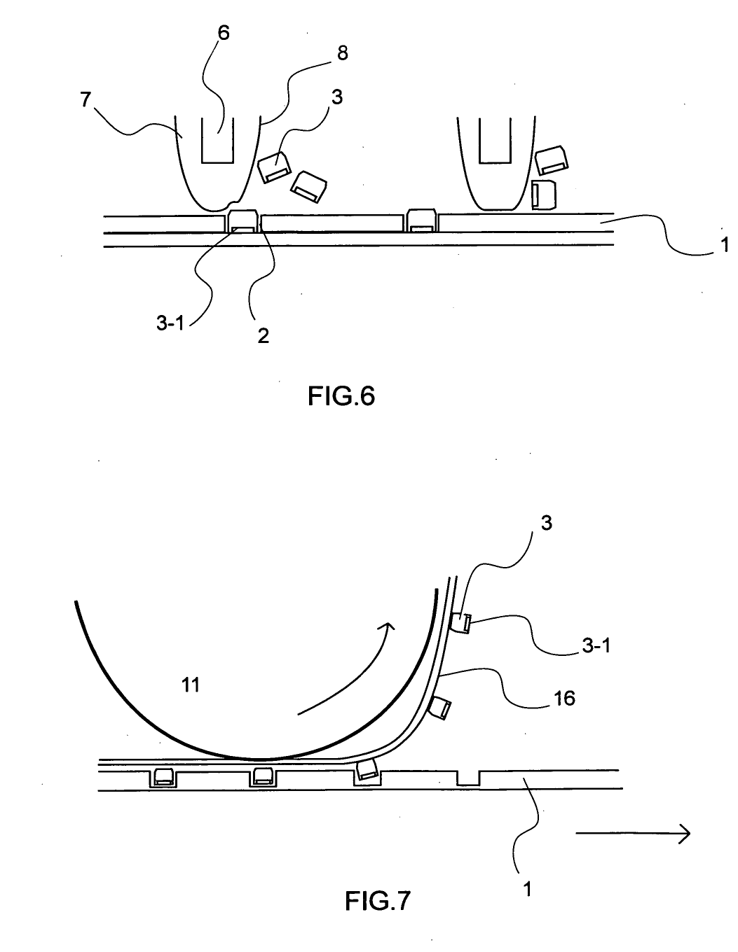

While the rubber plates (1) proceeds on the conveyer belt, beads (3) are spread on the rubber plate (5). FIG. 6 is a schematic cross sectional view showing how the locator (5) place beads (3) in circular grooves (2) developed on a rubber plate. High temperature melting glue (3-1) is pasted under the beads (3). Largest beads from first locator are placed into largest circular grooves first. Then second largest beads from second locator are placed into second largest circular grooves. As the rubber plate proceeds one direction according to movement of the conveyer (9), beads (3) having diameter that is same as the diameter of the circular grooves (2) are engaged into the circular grooves (2). In this step, the rubbery foam (7) material and a texture (8) covering the tip of the blades (6), (6-1) do a key role to place one bead (3) into one circular groove (2). Excess beads (3) are swept away from the occupied circular groove (2) by the rubbery foam (7) material and a texture (8).

FIG. 7 is a schematic cross sectional view showing how low temperature melting adhesive (16) paved plastic film (10) picks up the beads. As the beads (3) holding rubber plate (1) proceeds to next position, the low temperature melting adhesive (16) paved plastic film is introduced over the bead (3) holding rubber plate (1) via the first feeding roller (11). The beads (3) are picked up by the low temperature melting adhesive (16) and come out of the circular groove (2). In this step, the low temperature melting adhesive (16) paved on the film is sticky, but the high temperature melting glue (3-1) remains in solid state. Therefore, the beads (3) will come out of the groove (2) easily. While the low temperature melting adhesive (16) paved film (10), now pluralities of beads (3) are adhered thereon, is fed to the second feeding roller drawn by the upper second feeding roller (13-U), coarse surfaced peel off (12) is fed to the second feeding roller drawn by the lower roller (13-L).

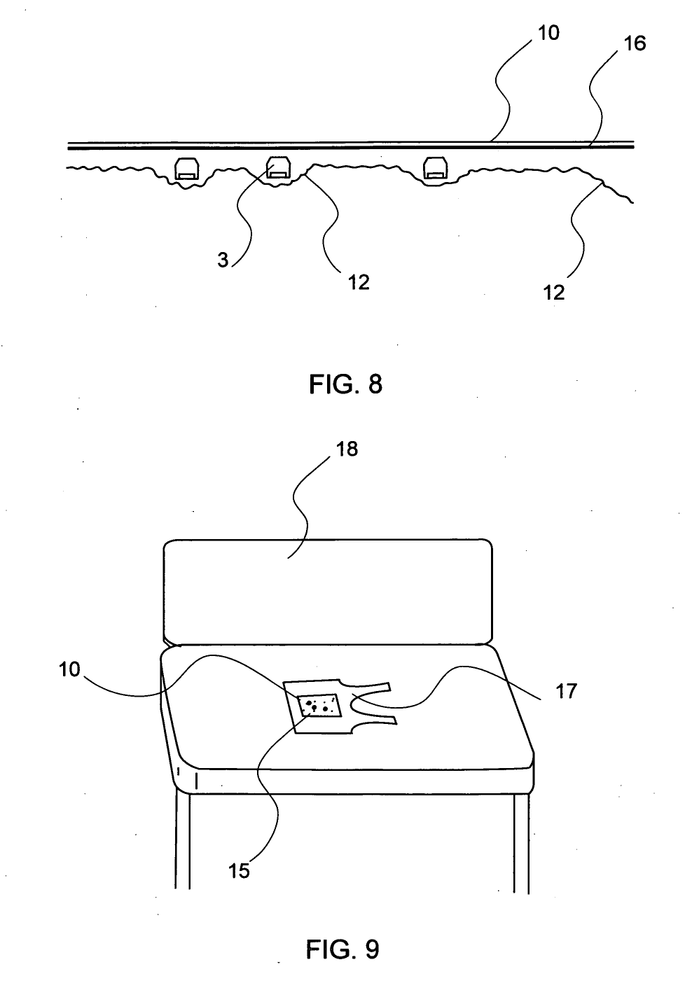

FIG. 8 is a schematic cross sectional view showing coarse surfaced peel off (12) is detachably adhered to the beads containing low temperature melting adhesive (16) paved plastic film (10). As the surface of the peel off (12) is coarse, the area of the peel off that contact with the adhesive is much less than flat surface. Therefore, the bonding force provided by the low temperature melting adhesive (16) is much weaker than the bonding force between two flat surfaces. The peel off is adhered to protect the beads (3) stay on the low temperature melting adhesive (16) while storing and transporting them to a garment manufacturer or a decorator.

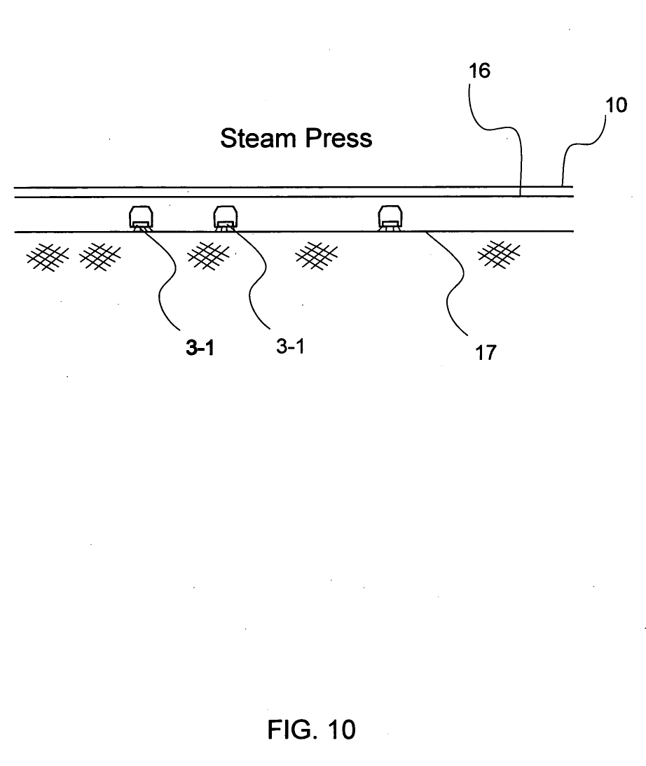

FIG. 9 is a schematic drawing how to transfer the ornamentally designed sequence of beads (3) to a garment (17). When a user try to transfer the ornamentally designed sequences of beads (3) on to a garment, the user place a garment on a steam press (18) and remove the peel off (12) from the transparent adhesive paved film (10). Temperature of the steam press is maintained at 90° C. Then place the film (10) on a desired area of the garment (17). And close the steam press (18) and press for 30 seconds. Then, bonding force of the low temperature melting adhesive (16) paved on the film (10) weakens as it melts and flows down to the garment as shown in FIG. 10. Then the beads fall down to the garment (17). The molten low temperature melting adhesive (16) is soaked into the texture of the garment (17).At the same time the high temperature adhesive (3-1) starts to melt and becomes a sticky state. The molten, high temperature melting adhesive (3-1) also is soaked into the fabric structure of the garment (17). Part of the low temperature melting adhesive (16) remains on the surface of the garment (17) holds the beads as it was arranged on the plastic film (10). Then the ornamentally designed sequence of the breads (3) is adhered on a garment successfully.

What is claimed is:

1. A locator for placing beads of predetermined size into a circular groove developed on a rubber plate and a method of producing decorative sequences of beads for garments with the locator is comprised of:
fill up a locator, which is a box type means whose upper side and bottom side are open and pluralities of blades are vertically located at the bottom side and additional blades are located at the bottom of out side of the locator along long side and lower end of the blades are covered with a layer of rubbery foam material inside and a cotton texture out side, with beads of predetermined, and
place beads of predetermined size, bottom surface of which are flat and are coated with high temperature melting adhesive, into ornamentally designed sequences of circular grooves on a rubber plate that is comprised of;
one rubber plate constituting an upper rubber plate, which has pluralities of holes, and another rubber plate constituting a lower rubber plate, adhered onto a conveyer belt, and
press a transparent plastic film, paved with low temperature melting adhesive, on the rubbery plate by passing through a pair of first feeding rollers, and
feed the low temperature melting adhesive paved film, with pluralities of the beads adhered thereon, to the second feeding roller drawn by an upper second feeding roller, while coarse surfaced peel off is fed to the second feeding roller drawn by the lower roller, and
roll up the transparent plastic film, which is paved with low temperature melting adhesive and covered with coarse peel off and contains omnamentally designed sequences of beads there between.

2. A method of transferring the ornamentally designed sequences of beads of claim 1 to a garment is comprised of:
place a garment on a steam press maintaining at 90° C., and remove a peel off from a transparent adhesive paved film containing ornamentally designed sequences of beads in claim 1, and
place the transparent adhesive paved film containing ornamentally designed sequences of beads in claim 1 on a desired area of a garment, and
close the steam press and press for 30 seconds.
